(19) United States
(12) Patent Application Publication
(10) Pub. No.: US 2016/0261208 A1
(43) Pub. Date: Sep. 8, 2016

(54) Multi-Decade Current-to-Voltage Converter

(71) Applicant: Raymond Thomas Rodgers, III, Troy, MI (US)

(72) Inventor: Raymond Thomas Rodgers, III, Troy, MI (US)

(21) Appl. No.: 14/641,413

(22) Filed: Mar. 8, 2015

(51) Int. Cl. H02M 11/00

(52) U.S. Cl. CPC H02M 11/00

(57) ABSTRACT

A multi-decade current-to-voltage conversion circuit capable of converting input currents over several orders of magnitude to a voltage over one order of magnitude without the use of range-switching circuits and while maintaining a linear current-voltage relationship. The conversion is accomplished through reverse-biased diode-resistor pairs arranged in a ladder network as the feedback element of an amplifying circuit.

### BACKGROUND OF THE INVENTION

Many ammeters implement some sort of current-to-voltage conversion circuit. These circuits respond either linearly with an input current or logarithmically. The benefit of a linear response is a constant resolution and measurement error throughout the entire measurement range. The drawback is a specific measurement range which may be too large or too small for a given application. A logarithmic response expands the measurement range over several orders of magnitude but generally has poorer performance than a linear response in any given range.

Precision ammeters attempt to extend the range of linear-response circuits by including many of them designed for specific ranges with which the instrument switches between. The switching can be done automatically when the ammeter detects an over- or under-range condition or manually by a user who expects a measurement to fall within a specific range.

The problems associated with switching circuits result from transients introduced back into the system under measurement when the ammeter switches between ranges. The switch takes a finite time during which the instrument's behavior is not well controlled. These transients can disrupt sensitive systems or cause erroneous measurements following the switch.

The present invention utilizes a dynamic resistance feedback network as a current-to-voltage converter to combine the advantages of a linear-response converter and a logarithmic-response converter. This allows the invention to accommodate many ranges of currents without a need for explicit switching. Furthermore, the accuracy of the invention is like that of a linear converter.

The following briefly describes the figures accompanying this invention:

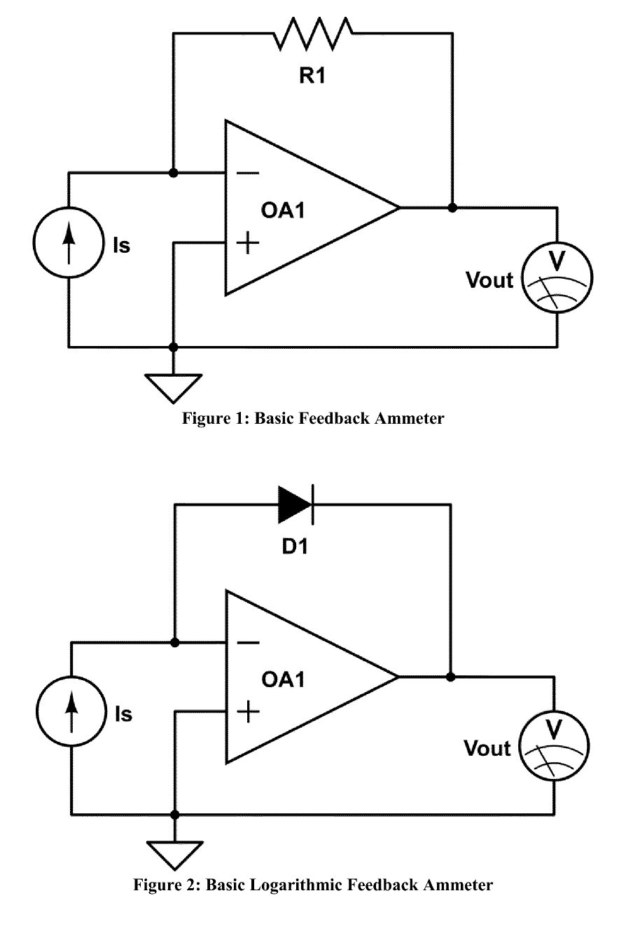

FIG. 1 is a schematic of a basic current-to-voltage converter circuit found in a typical feedback ammeter.

FIG. 2 is a schematic of a current-to-voltage converter circuit found in a logarithmic feedback ammeter.

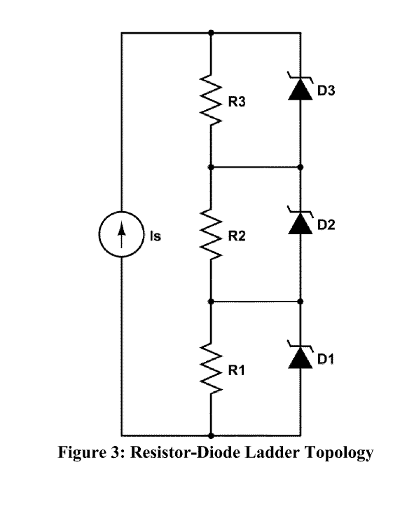

FIG. 3 is a schematic of the feedback element used in the present invention.

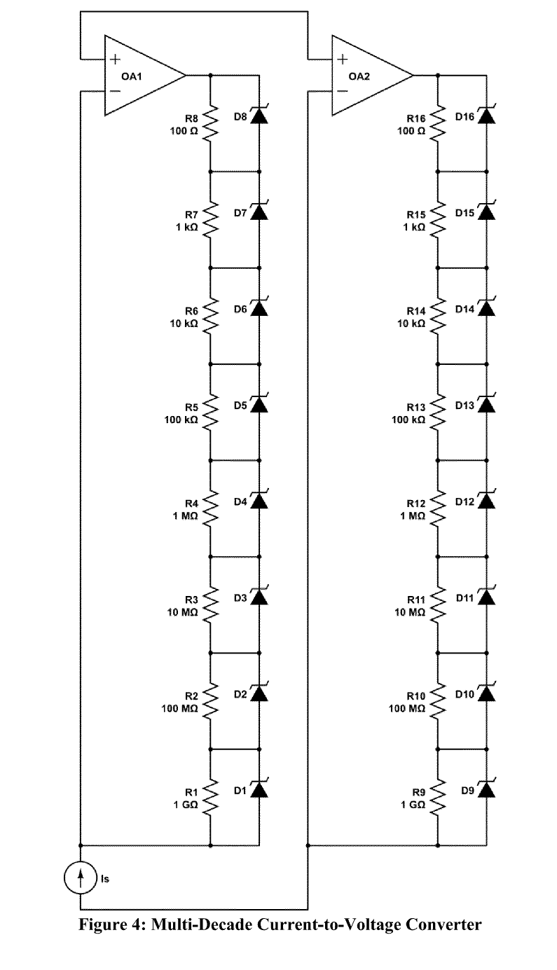

FIG. 4 is a schematic of an embodiment of the present invention: a bipolar, 8-decade current-to-voltage converter.

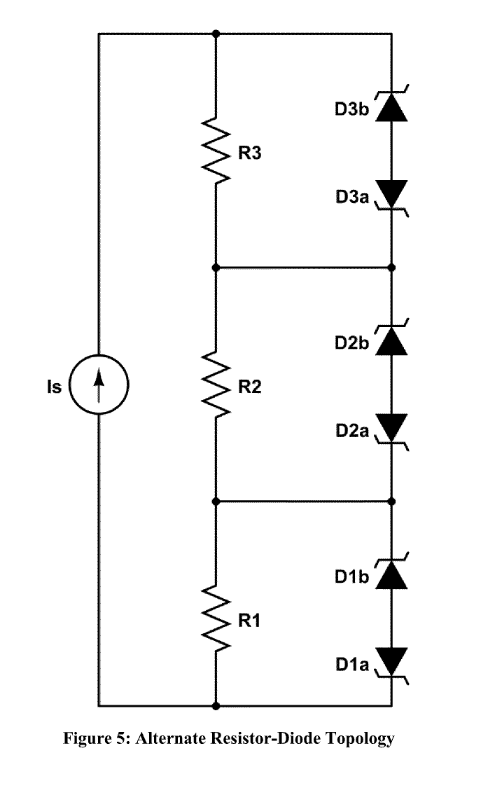

FIG. 5 is a schematic of an alternate feedback element for use in the present invention.

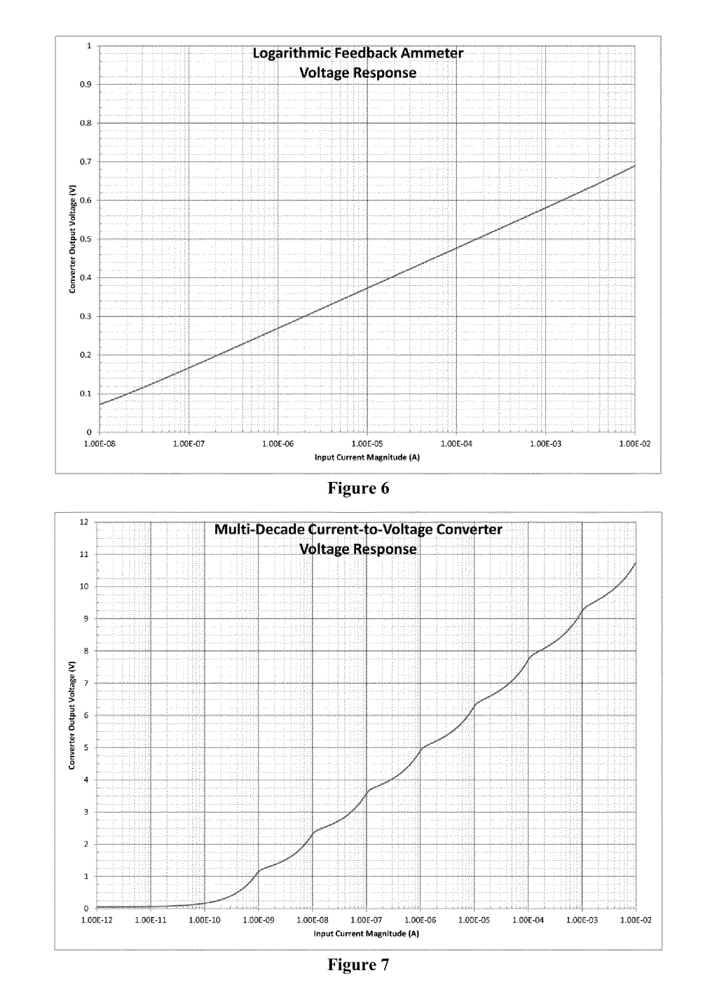

FIG. 6 is a plot of the amplifier output voltage of the logarithmic current-to-voltage converter seen in FIG. 2.

FIG. 7 is a plot of the amplifier output voltage of the 8-decade current-to-voltage converter seen in FIG. 4.

### SUMMARY OF THE INVENTION

The present invention implements a current-to-voltage conversion circuit with a combined linear-logarithmic voltage response while maintaining a capacity for high performance in terms of accuracy and speed. The invention utilizes a resistor-diode pair network as the feedback element of a negative feedback amplifier. The resistor-diode pairs are arranged in a ladder topology (FIG. 3) that allows for a wide dynamic range in the input current. Two such amplifiers can be placed in a back-to-back manner to allow for a bipolar input current.

Each resistor-diode pair, or stage, is a linear and non-linear resistance in parallel. Each stage is designed such that the diode has greater impedance than the resistor at low voltages across the stage. The resistor is the controlling resistance in this condition. The diode becomes more conductive as the voltage across the stage increases and eventually the diode becomes the controlling resistance.

The amplifier has a strong linear response to the input current while the current is small enough to not cause a large voltage drop across the resistor, and hence the stage. At some design voltage, the diode becomes much more conductive than the resistor, allowing current over several orders of magnitude to bypass the resistor. The next stage in the network is designed for a current one order of magnitude higher. Thus, multiple stages placed in series maintain the strong linear response of the amplifier over a wide range of input currents.

### DETAILED DESCRIPTION

The basic embodiment of the invention consists of: an operational amplifier (op-amp), at least two feedback resistors, and at least two diodes that are functional when reverse biased (such as a Zener diode). One resistor and one diode are paired together in parallel to form one stage of the feedback network. The stages are then placed in series between the amplifier output and the inverting input. The diodes have their cathodes towards the current input terminal. The feedback network consists of at least two resistor-diode stages.

Each stage is designed to a desired input current range. The desired range determines the resistor's resistance value through a choice of cutoff voltage. The cutoff voltage determines the reverse bias properties of the paired diode. The diode passes 10% of the stage's full-scale current at this cutoff voltage. Each stage is clamped to the cutoff voltage once the input current exceeds a given stage's range. The output of the op-amp is the sum of the voltages across each stage, from which a value and decade of the input current can be determined.

An example would be to select a resistor appropriate for a 1 nA (nano-amp) full-scale current range. The desired cutoff voltage might be 1 V. Thus a diode that passes 0.1 nA while reverse-biased at 1 V is chosen. The resistor passes the remaining 0.9 nA at 1 V which sets the resistance to 1.11 GΩ. The diode becomes more conductive as the voltage increases and bypasses a greater and greater proportion of the current. The next stage might be designed for a 10 nA range at a 1 V cutoff again. The diode in this stage would have to pass 1 nA at 1 V and the resistor passes the remaining 9 nA at 1 V, giving 111 MΩ.

An embodiment can consist of any number of stages in the feedback network. Two such feedback circuits can be placed in a back-to-back manner to allow for a bipolar input current. FIG. 4 shows such a configuration for 8 decades from 1 nA to 10 mA. FIG. 7 shows what the amplifier output voltage would look like for an input current from 1 pA to 10 mA. Compare to FIG. 6 which shows a pure logarithmic response for a logarithmic converter, such as the one shown in FIG. 2.

An alternate embodiment for the feedback network involves placing two diodes back-to-back for each stage instead of one. FIG. 5 shows this topology. This allows for a bipolar input current with only one operational amplifier. This is a simpler implementation of the present invention when a given application doesn't require the input terminals to be symmetric.

### PRIOR ART

| | |
|---|---|
| WO | High-dynamic ammeter with small time constant |
| 2009000236 A2 | |
| U.S. Pat. No. | Wide-dynamic range electrometer with a fast |
| 8,278,909 B2 | response |
| U.S. Pat. No. | Apparatus for measuring low currents with high |
| 4,692,693 A | dynamics |
| U.S. Pat. No. | Logarithmic current measurement circuit with |
| 5,327,029 A | improved accuracy and temp . . . |
| U.S. Pat. No. | Extended range log amplifier |
| 3,483,475 A | |
| U.S. Pat. No. | Logarithmic micro-microammeter having field-effect |
| 3,320,532 A | transistor in feedback . . . |
| WO | Continuous ranging ammeter and method of use |
| 2019097368 A1 | thereof |
| U.S. Pat. No. | Logarithmic amplifier |
| 3,448,289 A | |

1. A current-to-voltage conversion circuit comprising: a linear amplifier with an output voltage dependent on the difference of two separate input voltages; a negative feedback network connected between the amplifier output and the inverting input; the feedback network consists of an arbitrary number of stages stacked in series where each stage has a resistor and diode in parallel; the diodes are functional when reverse-biased; the input terminal of the current to be converted is connected to the inverting input of the amplifier; and the return terminal of the current to be converted is connected to the non-inverting input of the amplifier.

2. Two such circuits described in claim (1) can be connected in a back-to-back manner to allow for a bipolar input current where the inverting input of both amplifiers are the input and return terminals for the current to be converted.

3. A current-to-voltage conversion circuit comprising: a linear amplifier with an output voltage dependent on the difference of two separate input voltages; a negative feedback network connected between the amplifier output and the inverting input; the feedback network consists of an arbitrary number of stages stacked in series where each stage has a resistor in parallel with two back-to-back diodes; the diodes are functional when reverse-biased; the input terminal of the current to be converted is connected to the inverting input of the amplifier; and the return terminal of the current to be converted is connected to the non-inverting input of the amplifier.

4. The stages of the feedback network present a dynamic impedance to the input current where the impedance is dependent on the magnitude of the input current. The first stage resistor is chosen, according to Ohm's Law, for a specific maximum current with a cutoff voltage as the design point. The first stage diode is chosen such that it passes 5-30% of the maximum current when under reverse bias at the cutoff voltage. Subsequent stages are designed similarly but for increasing maximum currents.
